(19) United States
(12) Patent Application Publication
(10) Pub. No.: US 2023/0416443 A1
(43) Pub. Date: Dec. 28, 2023

(54) METHOD OF PRODUCING A COPOLYMER HAVING IMPROVED OIL RETENTION PROPERTIES

(71) Applicant: KURARAY CO., LTD., Okayama (JP)

(72) Inventors: Shinya Oshita, Houston, TX (US); Heith Foster, Houston, TX (US)

(73) Assignee: KURARAY CO., LTD., Okayama (JP)

(21) Appl. No.: 18/213,218

(22) Filed: Jun. 22, 2023

Related U.S. Application Data
(60) Provisional application No. 63/354,820, filed on Jun. 23, 2022.

(51) Int. Cl. C08F 297/04; C08F 2/26

(52) U.S. Cl. CPC C08F 297/046; C08F 2/26

(57) ABSTRACT

A method of producing a copolymer includes polymerizing monomers including 1,3-diene structure having 4 to 20 carbons in a solvent in a presence of an anionic polymerization initiator.

### FIELD OF THE INVENTION

The present invention relates to a method for producing a copolymer having low oil retention and reduced oil bleeding.

### SUMMARY OF THE INVENTION

According to one aspect of the invention, a method of producing a copolymer may include polymerizing monomers including 1,3-diene structure and having 4 to 20 carbons in a solvent in a presence of an anionic polymerization initiator to produce a copolymer. A temperature change during the polymerizing may be less than 15° C.

According to another aspect of the invention, a method of producing a copolymer may include polymerizing monomers including 1,3-diene structure and having 4 to 20 carbons in a solvent in a presence of an anionic polymerization initiator, and cooling a temperature during the polymerizing so that a consistency of the copolymer may be 6 mol % or less.

In some embodiments, the cooling may include maintaining a temperature change during the polymerizing to be less than 15° C.

In some embodiments, the temperature change during the polymerizing may be less than 10° C.

In some embodiments, the temperature change during the polymerizing may be 8° C. or less.

In some embodiments, a starting temperature of the polymerizing may be from 10 to 90° C.

In some embodiments, a starting temperature of the polymerizing may be from 40 to 70° C.

In some embodiments, the monomers may include butadiene.

In some embodiments, the monomers may include isoprene.

In some embodiments, the monomers may include 7,11-dimethyl-3-methylene-1,6,10-dodecatriene (β-farnesene).

In some embodiments, the only monomers polymerized in the polymerizing may consist of butadiene.

In some embodiments, the only monomers polymerized in the polymerizing may consist of isoprene.

In some embodiments, the only monomers polymerized in the polymerizing may consist of 7,11-dimethyl-3-methylene-1,6,10-dodecatriene (β-farnesene).

In some embodiments, the method may further include hydrogenating the copolymer, thereby producing a α-olefin random copolymer.

In some embodiments, the copolymer may be ethylene-1-butene copolymer.

In some embodiments, the copolymer may have a weight average molecular weight from 10,000 to 500,000 Da.

In some embodiments, the copolymer may have a content of vinyl bond structural units from 5 to 85 mol %.

According to another aspect of the invention, a method of producing a block copolymer may include polymerizing first aromatic vinyl compounds to produce polymerized aromatic vinyl compounds, and producing the copolymer according to the method disclosed herein, thereby producing the block copolymer including the polymerized first aromatic vinyl compounds and the copolymer. The solvent may contain the polymerized first aromatic vinyl compounds.

According to another aspect of the invention, a method of producing a tri-block copolymer may include producing the block copolymer according to the method disclosed herein, and polymerizing second aromatic vinyl compounds on the block copolymer, thereby producing the tri-block copolymer comprising the polymerized first aromatic vinyl compounds, the copolymer, and the polymerized second aromatic vinyl compounds.

In some embodiments, the first and second aromatic vinyl compounds may independently include a compound selected from the group consisting of styrene, α-methylstyrene, 4-methylstyrene, o-methylstyrene, m-methylstyrene, β-methylstyrene, 2,6-dimethylstyrene, 2,4-dimethylstyrene, α-methyl-o-methylstyrene, α-methyl-m-methylstyrene, α-methyl-p-methylstyrene, β-methyl-o-methylstyrene, β-methyl-m-methylstyrene, β-methyl-p-methylstyrene, 2,4,6-trimethylstyrene, α-methyl-2,6-dimethylstyrene, α-methyl-2,4-dimethylstyrene, 3-methyl-2,6-dimethylstyrene, f-methyl-2,4-dimethylstyrene, o-chlorostyrene, m-chlorostyrene, p-chlorostyrene, 2,6-dichlorostyrene, 2,4-dichlorostyrene, α-chloro-o-chlorostyrene, α-chloro-m-chlorostyrene, α-chloro-p-chlorostyrene, β-chloro-o-chlorostyrene, β-chloro-m-chlorostyrene, β-chloro-p-chlorostyrene, 2,4,6-trichlorostyrene, α-chloro-2,6-dichlorostyrene, α-chloro-2,4-dichlorostyrene, β-chloro-2,6-dichlorostyrene, β-chloro-2,4-dichlorostyrene, o-t-butylstyrene, m-t-butylstyrene, p-butylstyrene, o-methoxystyrene, m-methoxystyrene, p-methoxystyrene, o-chloromethylstyrene, m-chloromethylstyrene, p-chloromethylstyrene, o-bromomethylstyrene, m-bromomethylstyrene, p-bromomethylstyrene, silyl group-substituted styrene derivatives, indene, and vinylnaphthalene.

In some embodiments, each of the first and second aromatic vinyl compounds may include styrene.

In some embodiments, the tri-block copolymer may have a content of vinyl bond structural units from 5 to 85 mol %.

In some embodiments, the tri-block copolymer may have a styrene content from 5 wt % to 70 wt %.

In some embodiments, the tri-block copolymer may have a glass transition temperature (Tg) from −60° C. to 25° C. as measured with DSC at 10° C./min.

In some embodiments, the tri-block copolymer may have MFR at 230° C. and 2.16 kg of 250 g/10 min or less measured according to ISO1133.

In some embodiments, the first and second aromatic vinyl compounds may be polymerized by ionic polymerization.

In some embodiments, the anionic polymerization initiator may include at least one initiator selected from the group consisting of alkali metals; alkaline earth metals; lanthanoid rare earth metals; and compounds containing earth metals and lanthanoid rare earth metals.

In some embodiments, the anionic polymerization initiator may include at least one initiator selected from the group consisting of alkali metals, compounds containing alkali metals, and organic alkali metal compounds.

In some embodiments, the anionic polymerization initiator may include at least one alkali metal selected from the group consisting of lithium, sodium and potassium.

In some embodiments, the anionic polymerization initiator may include at least one alkaline earth metal selected from the group consisting of beryllium, magnesium, calcium, strontium and barium.

In some embodiments, the anionic polymerization initiator may include at least one lanthanoid rare earth metal selected from the group consisting of lanthanum and neodymium.

In some embodiments, the anionic polymerization initiator may include at least one organic alkali metal compound selected from the group consisting of methyl lithium, ethyl lithium, n-butyl lithium, sec-butyl lithium, t-butyl lithium, hexyl lithium, phenyl lithium, stilbene lithium, dilithiomethane, dilithionaphthalene, and 1,4-dilithiobutane.

In some embodiments, the anionic polymerization initiator may include an organic lithium compound.

In some embodiments, the anionic polymerization initiator may include at least one organic lithium compound selected from the group consisting of dilithiobutane, 1,4-dilithio-2-ethylcyclohexane, 1,3,5-trilithiobenzene, sodium naphthalene, and potassium naphthalene.

In some embodiments, the solvent may include at least one selected from the group consisting of saturated aliphatic hydrocarbons, cyclopentane, cyclohexane, methylcyclohexane, saturated alicyclic hydrocarbons, and aromatic hydrocarbons.

In some embodiments, the solvent may include at least one saturated aliphatic hydrocarbon selected from the group consisting of n-pentane, isopentane, n-hexane, n-heptane, and isooctane.

In some embodiments, the solvent may include at least one selected from the group consisting of pentane, benzene, toluene, and xylene.

In some embodiments, the solvent may further include a Lewis base.

In some embodiments, the solvent may further include at least one Lewis base selected from the group consisting of dibutyl ether, diethyl ether, tetrahydrofuran, dioxane, tetramethylethylenediamine, hexamethyltriethylenetetramine, 1,2-diethoxypropane, ditetrahydrofurylpropane, and ethylene glycol diethyl ether; pyridine; tertiary amines; alkali metal alkoxides; and phosphine compounds.

In some embodiments, an amount of the Lewis base may be in the range of 0.01-1000 molar equivalent with respect to 1 mol of the anionic polymerization initiator.

In some embodiments, the method may further include adding a polymerization terminator to the solvent.

In some embodiments, the polymerization terminator may include an alcohol.

In some embodiments, the method may further include precipitating the tri-block copolymer in another solvent.

In some embodiments, the method may further include washing the polymerization reaction liquid with water, separating, and drying.

Another aspect of the invention may relate to a tri-block copolymer produced by the method disclosed herein.

According to the aspects of the present invention, a method of producing a copolymer, which has superior oil retention properties and is suitable for 2K molding, grips and oil gel applications, is provided.

These and other embodiments, features and advantages of the present invention will be more readily understood by those of ordinary skill in the art from a reading of the following detailed description.

### BRIEF DESCRIPTION OF THE DRAWINGS

FIG. 1 is an illustration of calculating the vinyl content (VC) and consistency.

FIG. 2 is an illustration of the arrangement of polymeric sheets for the oil retention test and the oil retention performance for the tested hydrogenated tri-block polymers.

FIG. 3 is an illustration of the arrangement of polymeric sheets for the oil retention test.

### DETAILED DESCRIPTION

The present invention will now be illustrated in further detail.

In the context of the present description, all publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Unless stated otherwise, pressures expressed in psi units are gauge, and pressures expressed in kPa units are absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “predominant portion” or “predominantly”, as used herein, unless otherwise defined herein, means greater than 50% of the referenced material. If not specified, the percent is on a molar basis when reference is made to a molecule (such as hydrogen and ethylene), and otherwise is on a mass or weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

The term “depleted” or “reduced” is synonymous with reduced from originally present. For example, removing a substantial portion of a material from a stream would produce a material-depleted stream that is substantially depleted of that material. Conversely, the term “enriched” or “increased” is synonymous with greater than originally present.

The term “number-average molecular weight” or “Mn” means a number-average molecular weight, and the term “weight-average molecular weight” or “Mw” means a weight-average molecular weight, as determined by gel permeation chromatography (GPC) based on a standard polystyrene calibration curve.

Crystallization peak temperature (Tc) is determined herein using a differential scanning calorimeter (DSC), and is defined as the peak top temperature of the exothermic peak observed when the sample is heated from 30° C. to 200° C. at a temperature-increasing rate of 10° C./min and then cooled to −60° C. at a temperature-decreasing rate of 10° C./min. Measurement is as set forth in the Examples.

The term “thermoplastic” has its normal meaning, namely, a substance that can become plastic on heating and hardens on cooling through multiple cycles, as would be understood by a person of ordinary skill in the relevant art.

The term “elastomer” also has its normal meaning, namely, a substance that has elastic properties, as would be understood by a person of ordinary skill in the relevant art.

The term “substantially uniform mixture” means that the components of the mixture are substantially evenly distributed throughout the mixture on a mass basis. The mixture may have discontinuous domains (of the same or different sizes) of one component in a continuous domain of another component, in which case the discontinuous domains would be substantially evenly distributed within the continuous domain (on a mass basis). The intent is that the level of uniformity is that achievable by common industrial mixing equipment operated under commercially applicable conditions, as would be recognized by a person of ordinary skill in the relevant art.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising butadiene and 15 mol % of a comonomer”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such.

For convenience, many elements of the present invention are discussed separately, lists of options may be provided and numerical values may be in ranges; however, for the purposes of the present disclosure, that should not be considered as a limitation on the scope of the disclosure or support of the present disclosure for any claim of any combination of any such separate components, list items or ranges. Unless stated otherwise, each and every combination possible with the present disclosure should be considered as explicitly disclosed for all purposes.

Although methods and materials similar or equivalent to those described herein can be used in the practice or testing of the present disclosure, suitable methods and materials are described herein. The materials, methods, and examples herein are thus illustrative only and, except as specifically stated, are not intended to be limiting.

The present invention relates to a method of producing a copolymer that is superior in oil retention properties and is suitable for grips and oil gel applications. Further details are provided below.

### Polymerizing Monomers Including 1,3-Diene Structure

In one aspect, the method of the present disclosure may include polymerizing monomers including 1,3-diene structure and having 4 to 20 carbons in a solvent in a presence of an anionic polymerization initiator to produce a copolymer, wherein a temperature change during the polymerizing is less than 15° C.

In another aspect, the method of the present disclosure may include polymerizing monomers including 1,3-diene structure and having 4 to 20 carbons in a solvent in a presence of an anionic polymerization initiator, and cooling a temperature during the polymerizing so that a consistency of the copolymer is 6 mol % or less. In some embodiments, the cooling may include maintaining a temperature change during the polymerizing to be less than 15° C. In some embodiments, the cooling may include maintaining a temperature change during the polymerizing to be 20, 19, 18, 17, 16, 15, 14, 13, 12, 11, 10, 9, 8, 7, 6, 5, 4, or 3° C. or less.

The temperature change may refer to the difference between the lowest and highest temperatures measured throughout the polymerizing and includes the beginning and terminating of the polymerizing. The temperature during the polymerizing may be measured by a temperature sensor, which may be in contact with the polymerization mixture. Other methods and/or tools appreciated by one of ordinary skill in the art, even if not described in the present disclosure, may also be used.

In some embodiments, the temperature change during the polymerizing may be less than 14, 13, 12, 11, 10, 9, 8, 7, 6, 5, 4, 3, or 2° C. and/or more than 1, 2, 3, 4, 5, 6, or 7° C. In some embodiments, the temperature change during the polymerizing may be less than 10° C. In some embodiments, the temperature change during the polymerizing may be 8° C. or less. The temperature change may be controlled by a thermostat installed in a cooling device cooling the polymerization mixture. Other methods and/or tools appreciated by one of ordinary skill in the art, even if not described in the present disclosure, may also be used.

In some embodiments, a starting temperature of the polymerizing may be from 10 to 90° C. In some embodiments, a starting temperature of the polymerizing may be from 40 to 70° C. For example, a starting temperature of the polymerizing may be at least 10, 15, 20, 25, 30, 35, 40, 45, 50, 55, or 60° C. and/or not more than 70, 65, 55, 45, 35, 25, or 15° C. The polymerizing may be carried out for at least about 1, 2, 3, 4, 5, 6, 7, 8, 9, 10, 12, 15, 20, or 24 hours and/or not longer than 36, 30, 24, 20, 16, 12, 10, 8, 7, 6, 5, 4, 3, 2, or 1.5 hour.

The monomers may have at least 4, 5, 6, 7, 8, 9, 10, 11, 12, 13, 14, 15, 16, 17, 18, or 19 carbons and/or not more than 20, 19, 18, 17, 16, 15, 14, 13, 12, 11, 10, 9, 8, 7, 6, or 5 carbons.

In some embodiments, each C═C in the 1,3-diene structure may independently be a part of a cyclic structure or an aliphatic chain. The monomers may be unsubstituted or substituted with one or more moieties selected from the group consisting of hydroxyl, amino, alkylamino, arylamino, alkoxy, aryloxy, nitro, cyano, sulfonic acid, sulfate, phosphonic acid, phosphate, or phosphonate. One or more of the hydrogen atoms attached to a carbon atom in the monomer may be replaced by one or more halogen atoms, e.g., fluorine, chlorine, bromine, and/or iodine, such as trifluoromethyl, difluoromethyl, fluorochloromethyl, and the like as long as the substituent(s) does not interfere with the object and effect of the present invention. The hydrocarbon chain may also be interrupted by a heteroatom, such as N or O, and the like as long as the heteroatom does not interfere with the object and effect of the present invention.

In some embodiments, the monomers may include at least one of butadiene, isoprene, 2,3-dimethyl-butadiene, 1,3-pentadiene, 1,3-hexadiene, myrcene, and 7,11-dimethyl-3-methylene-1,6,10-dodecatriene (β-famesene), and the like, as long as they do not interfere with the object and effect of the present invention. In some embodiments, a mixture of monomers may be used, and the polymerization form of the copolymer may be random or block and may not be particularly limited. In some embodiments, the monomers may include butadiene. In some embodiments, the monomers may include isoprene. In some embodiments, the monomers may include 7,11-dimethyl-3-methylene-1,6,10-dodecatriene (β-famesene). The content of the monomers based on a total amount of monomers polymerized in the polymerizing may be at least 40, 50, 60, 70, 80, or 90 mol %, and/or not more than 99, 90, 80, 70, 60, or 50 mol %. In some embodiments, the only monomers polymerized in the polymerizing consist of butadiene.

In some embodiments, the only monomers polymerized in the polymerizing consist of isoprene. In some embodiments, the only monomers polymerized in the polymerizing consist of 7,11-dimethyl-3-methylene-1,6,10-dodecatriene (β-farnesene).

In addition, the copolymer may contain structural units derived from other polymerizable monomers, for example, structural units derived from aromatic vinyl compounds, such as styrene, α-methylstyrene, 2-methylstyrene, 3-methylstyrene, 4-methylstyrene, 4-propylene, 4-cyclohexylstyrene, 4-dodecylstyrene, 2-ethyl-4-benzylstyrene, 4-(phenylbutyl)styrene, and the like, as long as the object and effect of the present invention are not hindered. “Derived from other polymerizable monomers” means that the structural unit is a structural unit formed as a result of polymerization of other polymerizable monomers. The content of the structural unit derived from the other polymerizable monomer in the copolymer is preferably about 10% by mass or less, or about 5% by mass or less, or about 3% by mass or less, and or 0% by mass, based on the total mass of copolymer.

### Vinyl Content (NC)

There is no particular limitation on the bonding form of the monomer in the copolymer. For example, the monomers may be incorporated into the copolymer via the 1,2-bond or 3,4-bond and introduce pendant vinyl groups to the copolymer. In some embodiments, the monomers may be incorporated into the copolymer via the 1,4-bond and introduce unsaturation into the main polymer chain. Only one of these bonding forms may be present, or more than one may be present. In addition, any of these bonding forms may be present in any ratio.

The vinyl content (VC) may be a ratio of monomer units incorporated via the 1,2- and 3,4-bonds to a total molar amount of conjugated diene (1,3-diene structure) monomer units incorporated in the bonding mode of 3,4-, 1,4-, and 1,2-bonds of a conjugated diene monomer. The vinyl content may be measured using ¹H-NMR analysis of the block copolymer.

From the standpoint of oil retention properties, the amount of 1,2-bonding and 3,4-bonding may be 1, 2, 3, 5, 7, 10, 15, 20, 25, 30, 35, 40, or 45 mol % or more and/or 10, 15, 20, 25, 30, 35, 40, 45, or 50 mol % or less, based on total mol of repeating units in the copolymer. In some embodiments, the monomers may include butadiene, and the amount of 1,2-bonding and 3,4-bonding may be 30, 31, 32, 33, 34, 35, 36, 37, 38, 39, 40, 41, 42, 43, 44, or 45 mol % or more and/or 43, 44, 45, 46, 47, 48, 49, or 50 mol % or less, based on total mol of repeating units in the copolymer. In some embodiments, the monomers may include isoprene, β-farnesene, and/or a mixture including isoprene and butadiene, and the amount of 1,2-bonding and 3,4-bonding may be 1, 2, 3, 4, 5, 6, 7, 8, 9, 10, 11, 12, 13, 14, or 15 mol % or more and/or 8, 9, 10, 11, 12, 13, 14, 15, 16, 17, 18, 19, or 20 mol % or less, based on total mol of repeating units in the copolymer. In this specification, the 1,2-bonding and 3,4-bonding quantities are calculated from the ¹H-NMR spectrum of the copolymer prior to hydrogenation according to the methods described in the examples. In some embodiments, the amount of 1,4-bonding may be less than 97, 95, 93, 90, 85, 80, 75, 70, 65, 60, 55, 50, 45, 40, 35, 30, 25, 20, 15, 10, or 5 mol %, based on total mol of repeating units in the copolymer.

### Consistency

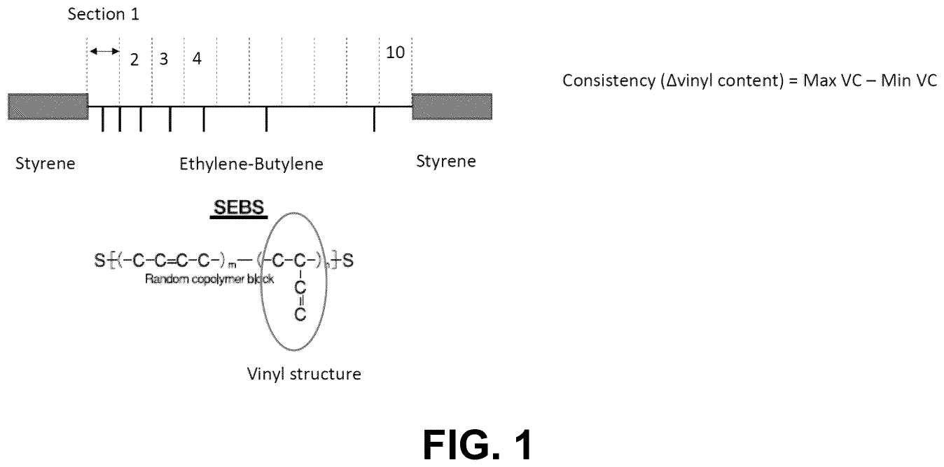

As used herein, “consistency” refers to a difference between the maximum and minimum vinyl contents (VCs) measured among a plurality of segments of the copolymer. VC may be measured using ¹H-NMR analysis of the block copolymer and may be obtained for the plurality of segments (e.g., 10 segments) in the copolymer. For example, see FIG. 1.

During the polymerization of the monomers including 1,3-diene structure, the polymerization mixture may be periodically sampled and analyzed for VC and conversion rate of the 1,3-diene structure. For example, the polymerization mixture may be sampled every 1, 2, 3, 4, 5, 6, 7, 8, 9, 10, 12, 15, 18, or 20 minutes. Methanol may be added to the sample to quench the polymerization process before the analysis.

The conversion rate may be defined as the percentage of monomers that are polymerized during the polymerization. The conversion rate may be measured by ¹H-NMR analysis or by measuring the weight of the isolated polymer after removing the solvent and unreacted monomers, if any.

VC for segments with conversion rates having about the same interval may be used in the analysis for consistency. For example, for 10 segments, the first through tenth segments may have a conversion rate of about 10%, 20%, 30%, 40%, 50%, 60%, 70%, 80%, 90%, and 100%, respectively, with the interval being about 10%. The interval may be about 5% (for 20 segments), 10% (for 10 segments), 20% (for 5 segments), or 25% (for 4 segments). For example, an interval of about 5% may be 5±0.1%, 5±0.2%, 5±0.3%, or 5±0.5%, an interval of about 10% may be 10±0.1%, 10±0.2%, 10±0.3%, or 10±0.5%, an interval of about 20% may be 20±0.1%, 20±0.2%, 20±0.3%, or 20±0.5%, and an interval of about 25% may be 25±0.1%, 25±0.2%, 25±0.3%, or 25±0.5%.

In some embodiments, from the standpoint of desirable oil retention properties, a consistency of the copolymer may be 6, 5.5, 5, 4.5, 4, 3.5, 3, 2.5, 2, 1.5, or 1 mol % or less and/or not more than 5, 4.5, 4, 3.5, 3, 2.5, 2, or 1.5 mol %.

### Hydrogenation of Copolymer

In some embodiments, the method according to the present disclosure may further include hydrogenating the copolymer, thereby producing a α-olefin random copolymer. As used herein, α-olefin is an organic compound that is an alkene (also known as olefin) with a chemical formula CₓH₂ₓ, distinguished by having a double bond at the primary or alpha (u) position. See, for example, Petrochemicals in Nontechnical Language, 3rd Edition, Donald L. Burdick and William L. Leffler.

In some embodiments, the copolymer may include ethylene-1-butene copolymer. In some embodiments, the copolymer may be ethylene-1-butene copolymer. In some embodiments, the copolymer may have a weight average molecular weight from 10,000 to 500,000 Da. For example, the weight average molecular weight may be at least 10,000, 50,000, 100,000, 150,000, 200,000, 300,000, or 400,000 Da and/or not more than 500,000, 450,000, 350,000, 250,000, 200,000, 150,000, 100,000, 80,000, or 40,000 Da.

In some embodiments, the copolymer may have a content of vinyl bond structural units from 5 to 85 mol %. In some embodiments, the copolymer may have a content of vinyl bond structural units of at least 5, 10, 15, 20, 30, 40, 50, 60, 70, or 80 mol %, and/or not more than 85, 75, 65, 55, 45, 35, 25, 20, 15, or 10 mol %. In some embodiments, when the copolymer may be formed from butadiene, the content of vinyl bond structural units refers to the content of the 1,2-bond structural unit (e.g., the pendant vinyl bond). In some embodiments, when the copolymer may be formed from isoprene, the content of vinyl bond structural units refers to the total content of the 1,2-bond structural unit and the 3,4-bond structural unit.

The copolymer may be hydrogenated at least about 30 mol %, about 40 mol %, about 50 mol %, about 60 mol %, about 70 mol %, about 80 mol %, about 90 mol %, about 95 mol %, or about 96 mol %, and/or up to 100 mol %, of carbon-carbon double bonds in the structural units derived from the monomers including 1,3-diene structure. This value is sometimes referred to as a hydrogenation rate.

In the above-mentioned hydrogenation, the content of the carbon-carbon double-bond in the structural units derived from the monomers including 1,3-diene structure in the copolymer may be measured by ¹H-NMR analysis before and after the hydrogenation, and the hydrogenation rate may be obtained from the measured values.

The hydrogenating of the copolymer may be carried out following the polymerizing or may be carried out after the copolymer is once isolated after the polymerizing.

In some embodiments, in isolating the copolymer after the polymerizing, the obtained polymerization reaction liquid may be poured into a poor solvent of the copolymer, such as methanol, to coagulate the copolymer, or the polymerization reaction liquid may be poured into hot water together with steam to remove the solvent by azeotrope (steam stripping) and then dried, to isolate the copolymer.

In some embodiments, when the polymerizing and hydrogenating are performed subsequently without isolating the copolymer, the α-olefin random copolymer may be isolated by pouring the hydrogenation reaction solution into a poor solvent of the α-olefin random copolymer, such as methanol, to solidify the α-olefin random copolymer, or by pouring the hydrogenation reaction solution into hot water together with steam to remove the solvent azeotropically (steam stripping) and then drying to isolate the α-olefin random copolymer.

The hydrogenating of the copolymer may be carried out in presence of a hydrogenation catalyst such as Raney nickel; a heterogeneous catalyst in which a metal such as platinum (Pt), palladium (Pd), ruthenium (Ru), rhodium (Rh), or nickel (Ni) is supported on a carrier such as carbon, alumina, or diatomaceous earth; a transition metal compound (nickel octylate, nickel naphthenate, nickel acetylacetonate, cobalt octylate, cobalt naphthenate, cobalt acetylacetonate, etc.) and a Zieglar-based catalyst consists of a combination of an organoaluminum compound such as triethylaluminum, triisobuthylaluminum, and an organolithium compound; and a metallocene-based catalyst consists of a bis(cyclopentadienyl) transition metal compound such as titanium, zirconium, hafnium, and organometallic compounds such as lithium, sodium, potassium, aluminum, zinc, magnesium. The reaction may be carried out at a reaction temperature of from about 20° C. to about 200° C., a hydrogen pressure of from about 0.1 MPa to about 20 MPa, and for a time of from about 0.1 hours to 100 hours.

### Method of Producing a Block Copolymer and a Tri-Block Copolymer

Another aspect of the disclosure relates to a method of producing a block copolymer, the method may include polymerizing first aromatic vinyl compounds to produce polymerized first aromatic vinyl compounds, and producing the copolymer according to the method disclosed herein, thereby producing the block copolymer comprising the polymerized first aromatic vinyl compounds and the copolymer, wherein the solvent contains the polymerized aromatic vinyl compounds.

The polymerized first aromatic vinyl compounds may be produced by polymerizing the first aromatic vinyl compounds using an alkyllithium compound or a dilithium compound as an initiator. Examples of the alkyllithium compound may include methyllithium, ethyllithium, n-butyllithium, sec-butyllithium, tert-butyllithium, and pentyllithium. Examples of dilithium compounds may include naphthalene dilithium, dithiohexyl benzene, and the like.

In some embodiments, the polymerized first aromatic vinyl compounds may correspond to a polymer block (a) that may contain about 50% by mass or more, or about 80% by mass or more, or about 90% by mass or more, or about 95% by mass or more, or substantially 100% by mass, of the polymerized first aromatic vinyl compound. The polymer block (a) may be composed of only one of the first aromatic vinyl compounds, or may be composed of two or more of the first aromatic vinyl compounds.

In some embodiments, the polymer block (a) may contain structural units derived from co-polymerizable monomers other than the first aromatic vinyl compounds, for example, conjugated dienes, such as isoprene, butadiene, 2,3-dimethyl-butadiene, 1,3-pentadiene, 1,3-hexadiene, 0-famesene, myrcene and the like, as long as they do not interfere with the object and effect of the present invention. The content of the structural unit derived from the co-polymerizable monomer in the polymer block (a) is preferably about 10% by mass or less, or about 5% by mass or less, or about 3% by mass or less, or substantially 0% by mass, based on the total mass polymer block (a).

The content of the polymer block (a) in block copolymer may be at least about 5, 10, 15, 20, 25, 30, 35, 40, 45, 50, 55, 60, or 65 wt %, and/or not more than about 70, 65, 60, 55, 50, 45, 40, 35, 30, 25, 20, 15, or 10 wt %, based on the total weight of the block copolymer. The content of the polymer block (a) in the block copolymer may be obtained from ¹H-NMR analysis.

In some embodiments, the block copolymer may include a polymer block (a) as described above and a polymer block (b) corresponding to the copolymer produced by the method disclosed herein (e.g., polymerizing monomers including 1,3-diene structure and having 4 to 20 carbons). The mode of bonding between the polymer block (a) and the polymer block (b) in the block copolymer may be any of linear, branched, radial, or any combination thereof.

For example, when the polymer block (a) is denoted by “A” and the polymer block (b) is denoted by “B,” there includes a diblock copolymer denoted by “A-B,” a tri-block copolymer denoted by “A-B-A,” a tetrablock copolymer denoted by “A-B-A-B,” a pentablock copolymer denoted by “A-B-A-B-A” and “B-A-B-A-B,” an (A-B)ₙX type copolymer (X represents a coupling agent residue, n represents an integer of 3, 4, 5, 6, 7, 8, 9, 10, 12, 15, or 20 or more), and the like.

Here, in the present specification, when polymer blocks of the same kind may be linearly bonded via a bifunctional coupling agent or the like, the entire bonded polymer block may be treated as one polymer block. In accordance therewith, including the above examples, polymer blocks which may be originally represented strictly as “Y-X-Y” (“X” represents a coupling residue and “Y” represents a polymer block) may be denoted as “Y” as a whole, except in particular when it is required to distinguish them from a single polymer block “Y.” Since this type of polymer block containing a coupling agent residue is handled as described above in this specification, for example, a block copolymer containing a coupling agent residue and to be strictly denoted as “A-B-X-B-A” (“X” represents a coupling agent residue) is denoted as “A-B-A,” and is handled as an example of a tri-block copolymer.

Examples of coupling agents include divinylbenzene; polyvalent epoxy compounds such as epoxidized 1,2-polybutadiene, epoxidized soybean oil, and 1,3-bis(N,N-glycidylaminomethyl)cyclohexane; halogen compounds such as dimethyldichlorosilane, dimethyldibromosilane, trichlorosilane, methyltrichlorosilane, tetrachlorosilane, and tetrachlorotin; ester compounds such as methyl benzoate, ethyl benzoate, phenyl benzoate, diethyl oxalate, diethyl malonate, diethyl adipate, dioctyl adipate, dimethyl phthalate, diethyl phthalate, dimethyl isophthalate, and dimethyl terephthalate; carbonated ester compounds such as dimethyl carbonate, diethyl carbonate, and diphenyl carbonate; and alkoxysilane compounds such as dimethyldimethoxysilane, methyltrimethoxysilane, methyltriethoxysilane, tetramethoxysilane, tetraethoxysilane, bis(trimethoxysilyl)hexane, and bis(triethoxysilyl)ethane.

In some embodiments, the block copolymer may be hydrogenated by the hydrogenation procedure disclosed herein. In some embodiments, the crystallization peak temperature (Tc) of the hydrogenated block copolymer may be from about −8, −5, −4, −3, −2.5, −2, −1.5, −1, −0.5, 0, 0.5, 1, 1.5, 2, 2.5° C. to about 3, 3.5, or 4° C. In some embodiments, the crystallization peak temperature (Tc) of the hydrogenated block copolymer may be not more than 4, 3.5, 3, 2.5, 2, 1.5, 1, 0.5, 0, −0.5, or −1° C.

In some embodiments, the weight average molecular weight (Mw) of the hydrogenated block copolymer may be from 10,000 to 500,000 Da. For example, the weight average molecular weight may be at least 10,000, 50,000, 100,000, 150,000, 200,000, 300,000, or 400,000 Da and/or not more than 500,000, 450,000, 350,000, 250,000, 200,000, 150,000, 100,000, 80,000, or 40,000 Da. In some embodiments, the weight average molecular weight of the hydrogenated block copolymer may be from about 50,000, or from about 60,000, or from about 65,000, or from about 70,000, to about 500,000, or to about 400,000, or to about 300,000, or to about 115,000.

The molecular weight distribution (Mw/Mn) of the hydrogenated block copolymer may be 1.5, 1.4, 1.3, 1.2, or 1.1 or less, or from about 1.01 to about 1.5, or to about 1.3, or to about 1.2, or to about 1.1, or to about 1.05.

In some embodiments, the hydrogenated block copolymer may have one or more functional groups, such as a carboxyl group, a hydroxyl group, an acid anhydride group such as maleic anhydride, an amino group and/or an epoxy group in the main chain and/or in the side chain as long as the effect of the present invention is not significantly impaired.

Another aspect of the disclosure relates to a method of producing a tri-block copolymer, the method may include producing the block copolymer according to the method disclosed herein, and polymerizing second aromatic vinyl compounds on the block copolymer, thereby producing the tri-block copolymer comprising the first aromatic vinyl compounds, the copolymer, and the polymerized second aromatic vinyl compounds. In some embodiments, the polymerized second aromatic vinyl compounds may correspond to a polymer block (c). In some embodiments, the tri-block copolymer may include the polymer block (a) described above and the polymer block (c) that may contain about 50% by mass or more, or about 80% by mass or more, or about 90% by mass or more, or about 95% by mass or more, or substantially 100% by mass, of structural units derived from the second aromatic vinyl compound. The polymer block (c) may be composed of only one of the second aromatic vinyl compounds, or may be composed of two or more of the second aromatic vinyl compounds. The polymer block (c) may be the same as or different from the polymer block (a) in terms of the structure of the structural units and/or the polymer chain length.

In some embodiments, the polymer block (c) may contain structural units derived from co-polymerizable monomers other than the second aromatic vinyl compounds, for example, conjugated dienes, such as isoprene, butadiene, 2,3-dimethyl-butadiene, 1,3-pentadiene, 1,3-hexadiene, β-farnesene, myrcene and the like, as long as they do not interfere with the object and effect of the present invention. The content of the structural unit derived from the co-polymerizable monomer in the polymer block (c) is preferably about 10% by mass or less, or about 5% by mass or less, or about 3% by mass or less, or substantially 0% by mass, based on the total mass polymer block (c).

In some embodiments, the first and second aromatic vinyl compounds may independently include a compound selected from the group consisting of styrene, α-methylstyrene, 4-methylstyrene, o-methylstyrene, m-methylstyrene, β-methylstyrene, 2,6-dimethylstyrene, 2,4-dimethylstyrene, α-methyl-o-methylstyrene, α-methyl-m-methylstyrene, α-methyl-p-methylstyrene, β-methyl-o-methylstyrene, β-methyl-m-methylstyrene, β-methyl-p-methylstyrene, 2,4,6-trimethylstyrene, α-methyl-2,6-dimethylstyrene, α-methyl-2,4-dimethylstyrene, 3-methyl-2,6-dimethylstyrene, f-methyl-2,4-dimethylstyrene, o-chlorostyrene, m-chlorostyrene, p-chlorostyrene, 2,6-dichlorostyrene, 2,4-dichlorostyrene, α-chloro-o-chlorostyrene, α-chloro-m-chlorostyrene, α-chloro-p-chlorostyrene, β-chloro-o-chlorostyrene, β-chloro-m-chlorostyrene, β-chloro-p-chlorostyrene, 2,4,6-trichlorostyrene, α-chloro-2,6-dichlorostyrene, α-chloro-2,4-dichlorostyrene, β-chloro-2,6-dichlorostyrene, β-chloro-2,4-dichlorostyrene, o-t-butylstyrene, m-t-butylstyrene, p-butylstyrene, o-methoxystyrene, m-methoxystyrene, p-methoxystyrene, o-chloromethylstyrene, m-chloromethylstyrene, p-chloromethylstyrene, o-bromomethylstyrene, m-bromomethylstyrene, p-bromomethylstyrene, silyl group-substituted styrene derivatives, indene, and vinylnaphthalene. The aromatic vinyl compounds may be used alone or in combination of two or more.

In some embodiments, each of the first and second aromatic vinyl compounds may include styrene.

In some embodiments, the tri-block copolymer may have a content of vinyl bond structural units from 5 to 85 mol %. In some embodiments, the tri-block copolymer may have a content of vinyl bond structural units of at least 5, 10, 15, 20, 30, 40, 50, 60, 70, or 80 mol %, and/or not more than 85, 75, 65, 55, 45, 35, 25, 20, 15, or 10 mol %.

In some embodiments, the tri-block copolymer may have a styrene content from 5 wt % to 70 wt %, based on a total weight of the tri-block copolymer. For example, the styrene content may be at least 5, 10, 15, 20, 25, 30, 35, 40, 45, 50, 55, 60, or 65 wt % and/or not more than 70, 65, 60, 55, 50, 45, 40, 35, 30, 25, 20, 15, or 10 wt %.

In some embodiments, the tri-block copolymer may have a glass transition temperature (Tg) from −60° C. to 25° C. as measured with DSC at 10° C./min. The Tg may be at least −60, −50, −40, −30, −20, −10, 0, 5, 10, 15, or 20° C. and/or not more than 25, 20, 15, 10, 5, 0, −10, or −20° C.

In some embodiments, the tri-block copolymer may have a melt flow rate (MFR) at 230° C. and 2.16 kg of 250 g/10 min or less measured according to ISO1133. The MFR may be 250, 100, 50, 20, 10, 5, 3, 1, 0.5, 0.1 g/10 min or less, and/or more than 100, 50, 20, 10, 5, 3, 1, 0.5, 0.1. In some embodiments, the MFR may be less than 0.1 g/10 min or no-flow.

In some embodiments, the first and second aromatic vinyl compounds may be polymerized by ionic polymerization.

In some embodiments, the tri-block copolymer may be hydrogenated by the hydrogenation procedure disclosed herein. In some embodiments, the hydrogenated ti-block copolymer may include the following repeating units in which i, k, l, m, and n are positive integers:

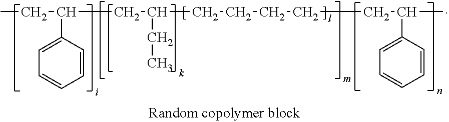

In some embodiments, the crystallization peak temperature (Tc) of the hydrogenated tri-block copolymer may be from about −8, −5, −4, −3, −2.5, −2, −1.5, −1, −0.5, 0, 0.5, 1, 1.5, 2, or 2.5° C. to about 3, 3.5, or 4° C. In some embodiments, the crystallization peak temperature (Tc) of the hydrogenated ti-block copolymer may be not more than 4, 3.5, 3, 2.5, 2, 1.5, 1, 0.5, 0, −0.5, or −1° C.

In some embodiments, the weight average molecular weight (Mw) of the hydrogenated tri-block copolymer may be from 10,000 to 500,000 Da. For example, the weight average molecular weight may be at least 10,000, 50,000, 100,000, 150,000, 200,000, 300,000, or 400,000 Da and/or not more than 500,000, 450,000, 350,000, 250,000, 200,000, 150,000, 100,000, 80,000, or 40,000 Da. In some embodiments, the weight average molecular weight of the hydrogenated tri-block copolymer may be from about 50,000, or from about 60,000, or from about 65,000, or from about 70,000, to about 500,000, or to about 400,000, or to about 300,000, or to about 115,000.

The molecular weight distribution (Mw/Mn) of the hydrogenated tri-block copolymer may be 1.5, 1.4, 1.3, 1.2, or 1.1 or less, or from about 1.01 to about 1.5, or to about 1.3, or to about 1.2, or to about 1.1, or to about 1.05.

In some embodiments, the hydrogenated tri-block copolymer may have one or more functional groups, such as a carboxyl group, a hydroxyl group, an acid anhydride group such as maleic anhydride, an amino group and/or an epoxy group in the main chain and/or in the side chain as long as the effect of the present invention is not significantly impaired.

In some embodiments, the compounds including the hydrogenated tri-block copolymer and oil (hydrogenated tri-block copolymer/oil=100/200 phr) may have a half-width, as measured by ¹³C DD/MAS NMR, of more than 0.65, 0.66, 0.67, 0.68, 0.69, 0.70, 0.71, 0.72, 0.73, 0.74, 0.75, or 0.76 ppm and/or less than 0.78, 0.77, 0.76, 0.75, 0.74, 0.73, 0.72, 0.71, 0.70, 0.69, 0.68, 0.67, or 0.66 ppm. The method for measuring the single width is described further in the Examples.

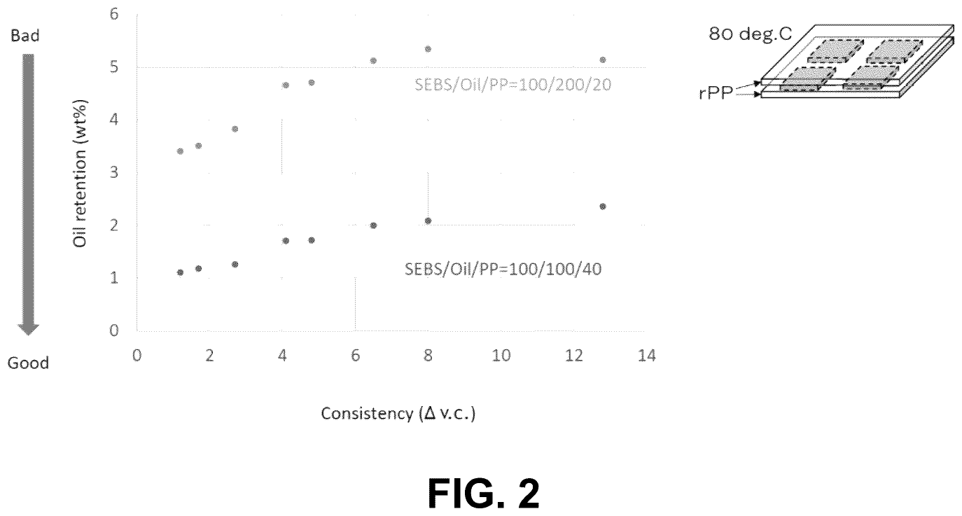

The compounds including the hydrogenated ti-block copolymer, oil, and polypropylene (PP) (hydrogenated ti-block copolymer/oil/PP=100/100/40 phr) may be formed into sheets, for example, as shown in FIG. 2, and sandwiched between two random polypropylene (PP, 2mmt, Flint Hills, 13T25A) plates to test for oil retention properties. In some embodiments, when the sheets having the composition of hydrogenated ti-block copolymer/oil/PP=100/100/40 are tested, the oil retention may be less than 2.0, 1.9, 1.8, 1.7, 1.6, 1.5, 1.4, 1.3, 1.2, or 1.1 wt %, based on a total weight of the sheets as described further in the examples, and/or more than 0.1, 0.2, 0.3, 0.4, 0.5, 0.6, 0.7, 0.8, or 0.9 wt %. In some embodiments, when compounds including the hydrogenated tri-block copolymer, oil, and PP (hydrogenated ti-block copolymer/oil/PP=100/200/20) may be formed into sheets, the sheets may be tested, and the oil retention may be less than 5.0, 4.9, 4.8, 4.7, 4.6, 4.5, 4.4, 4.3, 4.2, 4.1, 4.0, 3.9, 3.8, 3.7, 3.6, or 3.5 wt %, based on the total weight of the sheets, and/or more than 3.0, 3.1, 3.2, or 3.3 wt %.

### Anionic Polymerization Initiator

The copolymer may be produced by, for example, an anionic polymerization method involving an anionic polymerization initiator. In some embodiments, the anionic polymerization initiator may include at least one initiator selected from the group consisting of alkali metals; alkaline earth metals; lanthanoid rare earth metals; and compounds containing earth metals and lanthanoid rare earth metals. In some embodiments, the anionic polymerization initiator may include at least one initiator selected from the group consisting of alkali metals, compounds containing alkali metals, and organic alkali metal compounds. In some embodiments, the anionic polymerization initiator may include at least one alkali metal selected from the group consisting of lithium, sodium and potassium. In some embodiments, the anionic polymerization initiator may include at least one alkaline earth metal selected from the group consisting of beryllium, magnesium, calcium, strontium and barium.

In some embodiments, the anionic polymerization initiator may include at least one lanthanoid rare earth metal selected from the group consisting of lanthanum and neodymium. In some embodiments, the anionic polymerization initiator may include at least one organic alkali metal compound selected from the group consisting of methyl lithium, ethyl lithium, n-butyl lithium, sec-butyl lithium, t-butyl lithium, hexyl lithium, phenyl lithium, stilbene lithium, dilithiomethane, dilithionaphthalene, and 1,4-dilithiobutane. In some embodiments, the anionic polymerization initiator may include an organic lithium compound. In some embodiments, the anionic polymerization initiator may include at least one organic lithium compound selected from the group consisting of dilithiobutane, 1,4-dilithio-2-ethylcyclohexane, 1,3,5-trilithiobenzene, sodium naphthalene, and potassium naphthalene.

### Solvent

The polymerizing of the monomers may be carried out in the presence of a solvent. The solvent is not particularly limited as long as it is inert to the initiator and does not adversely affect the polymerizing. In some embodiments, the solvent may include at least one selected from the group consisting of saturated aliphatic hydrocarbons, cyclopentane, cyclohexane, methylcyclohexane, saturated alicyclic hydrocarbons, and aromatic hydrocarbons. In some embodiments, the solvent may include at least one saturated aliphatic hydrocarbon selected from the group consisting of n-pentane, isopentane, n-hexane, n-heptane, and isooctane. In some embodiments, the solvent may include at least one saturated aliphatic hydrocarbon such as hexane, cyclohexane, heptane, octane, and decane. In some embodiments, the solvent may include at least one selected from the group consisting of pentane, benzene, toluene, and xylene.

### Lewis Base

A Lewis base may be used as a cocatalyst in the polymerizing. In some embodiments, the solvent may further include a Lewis base. In some embodiments, the solvent may further include at least one Lewis base selected from the group consisting of dibutyl ether, diethyl ether, tetrahydrofuran, dioxane, tetramethylethylenediamine, hexamethyltriethylenetetramine, 1,2-diethoxypropane, ditetrahydrofurylpropane, ethylene glycol diethyl ether, pyridine, tertiary amines, alkali metal alkoxides, and phosphine compounds. Examples of the Lewis base include ethers, such as dimethyl ether, diethyl ether, and tetrahydrofuran; glycol ethers, such as ethylene glycol dimethyl ether and diethylene glycol dimethyl ether; and amines, such as triethylamine, N, N′, N′-tetramethylethylenediamine, and N-methylmorpholine. In some embodiments, the Lewis base may include tetrahydrofuran and/or tetramethylethylenediamine. In some embodiments, the Lewis base may be tetrahydrofuran. In some embodiments, the Lewis base may be tetramethylethylenediamine.

In some embodiments, an amount of the Lewis base is in the range of 0.01-1000 molar equivalent with respect to 1 mol of the anionic polymerization initiator. In some embodiments, the amount of the Lewis base may be at least 0.01, 0.1, 0.5, 2, 5, 10, 20, 50, 100, 200, 300, 500, 700, 800, or 900 molar equivalent with respect to 1 mol of the anionic polymerization initiator, and/or not more than 1000, 950, 850, 750, 550, 350, 250, 150, 75, 40, 30, 25, 15, 7, 5, 3, or 1 molar equivalent with respect to 1 mol of the anionic polymerization initiator.

In some embodiments, the method may include adding a polymerization terminator to the solvent. The addition of the polymerization terminator may occur before the hydrogenation of the copolymer, block copolymer, and/or tri-block copolymer. In some embodiments, the polymerization terminator may include an active hydrogen compound such as alcohols, carboxylic acids, and water. In some embodiments, the polymerization terminator may include an alcohol.

In some embodiments, the method may further include precipitating the tri-block copolymer in another solvent.

In some embodiments, the method may further include washing the polymerization reaction liquid with water, separating, and drying.

Another aspect of the disclosure relates to a tri-block copolymer produced by the method disclosed herein. In some embodiments, the tri-block copolymer may be incorporated into formulations that may include, for example, paraffin oil, process oil, bio-based oil, tackifier, filler, additives, and polyolefins such as polyethylene and polypropylene.

### EXAMPLES

The present invention is more specifically described by way of examples. The scope of the present invention, however, is not limited to these examples.

### Example 1: Production of Hydrogenated Tri-Block Copolymer

50 kg of cyclohexane as a solvent and 0.024 kg of 10.5% by weight sec-butyllithium (cyclohexane solution) as an initiator were charged into a nitrogen-substituted and dried pressure-resistant vessel, the temperature was raised to 50° C., and then 1 kg of styrene was added thereto to polymerize the solution for 60 minutes.

Thereafter, at the same temperature, 0.98 kg of THF as a Lewis base was added, and then 4.8 kg of butadiene was added over a period of 300 minutes and then the reaction was continued for another 30 minutes. During the polymerization of butadiene, the vessel was cooled accordingly so that the variation in temperature is within 2° C. (i.e., 50±2° C.) as measured by a temperature controller (LT370, Chino) and listed in Table 1. The polymerization mixture was sampled periodically to measure the 1,3-diene conversion and VC of each segment by ¹H-NMR.

Further, 1 kg of styrene was added at the same temperature to polymerize for 60 minutes, and then the polymerization was stopped with methanol to obtain a reaction solution containing a polystyrene-polybutadiene-polystyrene tri-block copolymer.

To this reaction solution, a Ziegler-based hydrogenation catalyst formed of nickel octylate and trimethylaluminum was added as hydrogenation catalyst under a hydrogen atmosphere, and hydrogenation reaction was carried out 1 MPa hydrogen pressure at 80° C. for 5 hours. After cooling and releasing the pressure, hydrogenation catalyst was removed by washing with water, the residue was concentrated and dried under vacuum to obtain a hydrogenated product of polystyrene-poly(ethylene/butylene)-polystyrene tri-block copolymer (hereinafter referred to as hydrogenated tri-block copolymer or SEBS).

### Examples 2-5 and Comparative Examples 1-3

The hydrogenated tri-block copolymers for Examples 2-5 and Comparative Examples 1-3 were prepared similarly to Example 1 with the only difference being the diene polymerization conditions stated in Table 1.

TABLE 1

| | EX 1 | EX 2 | EX 3 | EX 4 | EX 5 | CE 1 | CE 2 | CE 3 |
|---|---|---|---|---|---|---|---|---|
| Diene | 2 | 4 | 5 | 6 | 8 | 15 | 20 | 20 |
| poly- | | | | | | | | |
| merization | | | | | | | | |
| temperature | | | | | | | | |
| range | | | | | | | | |
| Starting | 50 | 49 | 61 | 50 | 51 | 52 | 53 | 52 |
| temperature | | | | | | | | |
| of diene | | | | | | | | |
| poly- | | | | | | | | |
| merization | | | | | | | | |
| Lewis base | THF | THF | THF | TMEDA | THF | THF | THF | TMEDA |

### Hydrogenated Tri-Block Copolymer Characteristics

Chemical structure of the obtained hydrogenated ti-block copolymer were evaluated according to the following methods and the results are summarized in Table 2. Hydrogenated tri-block copolymers in Examples 1 to 5 prepared according to the disclosed method had a consistency of 4.8 mol % or less and a crystallization temperature of 3.6° C. or less. In contrast, hydrogenated ti-block copolymers in Comparative Examples 1 to 3 prepared with a wider diene polymerization temperature range had a consistency of 6.5 mol % or more and a higher crystallization temperature of 4.7° C. or higher.

TABLE 2

| | EX 1 | EX 2 | EX 3 | EX 4 | EX 5 | CE 1 | CE 2 | CE 3 |
|---|---|---|---|---|---|---|---|---|
| Weight average | 280,000 | 280,000 | 280,000 | 280,000 | 280,000 | 280,000 | 280,000 | 280,000 |
| molecular weight (Mw) | | | | | | | | |
| Polystyrene content | 30 | 30 | 30 | 30 | 30 | 30 | 30 | 30 |
| (wt %) | | | | | | | | |
| Hydrogenation rate | 99 | 99 | 99 | 99 | 99 | 99 | 99 | 99 |
| (mol %) | | | | | | | | |
| Consistency-ΔVC | 1.2 | 1.7 | 2.7 | 4.1 | 4.8 | 6.5 | 8.0 | 12.8 |
| (mol %) | | | | | | | | |
| Total VC (mol %) | 39.0 | 39.6 | 38.5 | 39.0 | 39.0 | 39.5 | 37.8 | 39.5 |
| Tc-DSC(° C.) | −3 | −2.7 | 2.7 | n.d.* | 3.6 | 4.7 | 8.7 | 9.1 |

*not determined

### Consistency and Total Vinyl Content

The vinyl content (VC) is a ratio of conjugated diene monomer units incorporated via the 1,2- and 3,4-bonds to a total molar amount of conjugated diene monomer units incorporated in the bonding mode of 3,4-, 1,4-, and 1,2-bonds of a conjugated diene monomer before hydrogenation. VC was measured using the ¹H-NMR spectrum of the tri-block copolymer before hydrogenation. During the polymerization of butadiene, the polymerization mixture was sampled every 2 minutes, and methanol was added to the sample to quench the polymerization process before the analysis.

VC was calculated for each of 10 sections (segments) in the diene polymer block (polymer block (B)). For example, see FIG. 1. The first through tenth sections had a conversion rate of about 10%, 20%, 30%, 40%, 50%, 60%, 70%, 80%, 90%, and 100%, as obtained from ¹H NMR analysis. The 10 sections had about the same mass. Consistency was obtained by taking the difference between the maximum and minimum VCs measured for the 10 sections of the diene polymer block.

### Vinyl Bond Amount in Polymer Block (B)

The unhydrogenated tri-block copolymer was dissolved in CDCl₃ and analyzed through the ¹H-NMR measurement [apparatus: “ADVANCE 400 Nano Bay” (available from Bruker Corporation), measurement temperature: 30° C.]. From the ratio of the peak area corresponding to the 1,2-bond unit in the butadiene structural unit relative to the total peak area of the structural units derived from butadiene, the vinyl bond amount was calculated.

### Measurement of Crystallization Peak Temperature (Tc)

Differential scanning calorimetry (DSC) was used to determine the crystallization peak temperature (Tc) from the exothermic peak observed in the temperature-lowering process of the following 4th step, and the glass transition temperature from the endothermic peak observed in the temperature-raising process of the following 3rd step.
Equipment: DSC Q2000 (manufactured by TA instruments)
Temperature rise rate: 10° C./min
Temperature reduction rate: 10° C./min
Nitrogen flow: 50 mL/min

Temperature Profile
1st: Equilibrate at 30° C.→200° C. (held for 3 minutes)
2nd: 200° C.→−60° C. (held for 3 minutes)
3rd: −60° C.→200° C. (held for 3 minutes)
4th: 200° C.→−60° C.

### Styrene Content

The hydrogenated tri-block copolymer was dissolved in CDCl₃ and analyzed through the ¹H-NMR measurement [apparatus: “ADVANCE 400 Nano Bay” (available from Bruker Corporation), measurement temperature: 30° C.], and the styrene content was calculated from the peak intensity derived from styrene.

### Hydrogenation Rate of Polymer Block (B)

The hydrogenated tri-block copolymer was dissolved in CDCl₃ and analyzed through the ¹H-NMR measurement [apparatus: “ADVANCE 400 Nano Bay” (available from Bruker Corporation), measurement temperature: 30° C.]. From the ratio of the peak area derived from hydrogenated butadiene to the peak area derived from the residual olefin of butadiene, the hydrogenation rate was calculated.

### Weight Average Molecular Weight (Mw)

A weight average molecular weight (Mw) of the hydrogenated tri-block copolymer as expressed in terms of polystyrene was determined through gel permeation chromatography (GPC) under the conditions mentioned below. In addition, with respect to the polymer block (a) only, before the addition of the conjugated diene compound, the Mw was measured by the same procedures.

GPC Measurement Apparatus and Measurement Conditions
Apparatus: GPC apparatus “HLC-8020” (available from Tosoh Corporation)
Separation columns: Two columns of “TSKgel G4000HX” (available from Tosoh Corporation) were connected in series.
Eluent: Tetrahydrofuran
Eluent flow rate: 0.7 mL/mm
Sample concentration: 5 mg/10 mL
Column temperature: 40° C.
Detector: Differential refractive index (RI) detector
Calibration curve: Drawn using standard polystyrene
   Extruding and Injection Molding Hydrogenated Tri-Block Copolymers Formulated with Oil

The hydrogenated ti-block copolymers were extruded on a 27 mm Leistritz twin screw extruder with eleven barrel zones, 52:1 L/D, gear pump, screen changer and 6 hole die. Pellets were made via Gala underwater cutter and spin dryer system with water at approximately 50-60f. Oil (Krystol 550, Petro-Canada Lubricants Inc.) and homo polypropylene (Flint Hills, P4G2Z) were added to the crumb hydrogenated ti-block copolymers by high intensity mixer that was able to generate shear and heat into the hydrogenated tri-block copolymers to facilitate oil uptake and equalization across each batch and from batch to batch. For half-width NMR studies, 100 parts by weight of the hydrogenated tri-block copolymer was mixed with 200 parts by weight of oil. For oil retention studies, the formulations were prepared according to the compositions indicated in Table 3.

Sample plaques for oil retention and half-width NMR studies were obtained by injection molding using a TOYO Si-90-6 machine with the F200HDU high speed injection unit. Conditions of the injection screw were in the range of 200-230° C. with a mold temperature between 20° C. and 45° C. The mold insert with single gate system, was used to prepare a sheet having 2 mm thickness×125 mm length×125 mm width from which test samples were die cut to 1″×2″ (1 inch by 2 inches) to ensure uniformity. The test conditions are described herein and the results of the oil retention and half-width NMR studies are summarized in Tables 3 and 4, respectively. In Table 3, Examples 1A-5A included hydrogenated tri-block copolymers described in Examples 1-5, respectively, and Comparative Examples 1A-3A included hydrogenated tri-block copolymers described in Comparative Examples 1-3, respectively. The results of oil retention studies are also illustrated in FIG. 2. Examples 1A-5A, which included hydrogenated tri-block copolymers in Examples 1 to 5, respectively, had oil retention of 1.7 wt % or less (at SEBS/Oil/PP=100/100/40) and 4.7 wt % or less (at SEBS/Oil/PP=100/200/20). Comparative Examples 1A-3A had oil retention of 2.0 wt % or more (at SEBS/Oil/PP=100/100/40) and 5.1 wt % or more (at SEBS/Oil/PP=100/200/20). Thus, the hydrogenated tri-block copolymers in Examples 1 to 5 imparted significantly lower oil retention in Examples 1A-5A as compared to hydrogenated tri-block copolymers in Comparative Examples 1 to 3.

TABLE 3

| | | | | | | | |
|---|---|---|---|---|---|---|---|
| EX 1A | EX2A | EX 3A | EX 4A | EX 5A | CE1A | CE2A | CE3A |

Oil retention (wt %)

| | | | | | | | | |
|---|---|---|---|---|---|---|---|---|
| SEBS/Oil/PP = 100/100/40 | 1.1 | 1.2 | 1.3 | 1.7 | 1.7 | 2.0 | 2.1 | 2.4 |
| SEBS/Oil/PP = 100/200/20 | 3.4 | 3.5 | 3.8 | 4.7 | 4.7 | 5.1 | 5.3 | 5.1 |

### Oil Retention Properties

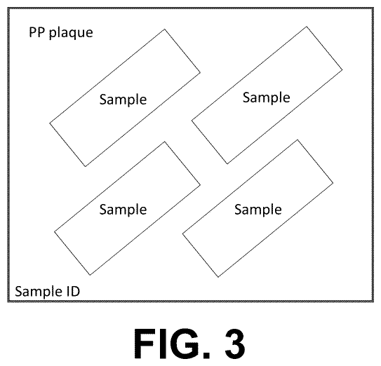

An injection mold 25 MFR, RCP PP plaque was used as a base. The non-ejector pin side of the RCP PP plaque was used as the test surface. A film die was used to cut out four rectangle slabs from sample plaques to be tested and all of the four slabs were weighed together. This weight corresponds to W₁. The RCP PP plaque was placed on a metal oil retention fixture. The slabs were placed individually (not stacked) on the RCP PP plaque and were arranged to avoid contact with adjacent slabs. See, e.g., FIG. 3. Another RCP PP plaque was placed on top of slabs such that injector pin marks faced away from slabs. A metal weigh down plate was placed on top of the RCP PP/4 slab/RCP PP sample set to prevent warping of the plaques. The sample fixture was placed in the oven set at 80° C. and was removed from the oven after 500 hours. The metal plate was left on the sample set, and the sample set was allowed to cool on the counter for an hour total. During the last 15 minutes, the metal plate was removed from the top of sample set to facilitate the cooling process. The top RCP PP plaque was then removed, and the four slabs were then weighed together. This weight corresponds to W₂. The weight of the four slabs were taken a second time to verify that the sample weight was not changed and that the samples were cooled fully. The wt % loss was calculated by the following formula:

$$\% weight loss = \frac{{W}_{1} - {W}_{2}}{{W}_{1}} \times 100 \%$$

In Table 4, Examples 1B-5B included hydrogenated tri-block copolymers described in Examples 1-5, respectively, and Comparative Examples 1B-3B included hydrogenated tri-block copolymers described in Comparative Examples 1-3, respectively.

TABLE 4

| | EX 1B | EX 2B | EX 3B | EX 4B | EX 5B | CE 1B | CE 2B | CE 3B |
|---|---|---|---|---|---|---|---|---|
| Half width-NMR (ppm) | 0.77 | 0.74 | 0.70 | n.d. | 0.68 | 0.66 | 0.66 | 0.65 |

### Half-Width-NMR

A half-width-NMR was calculated by following the steps. A ¹³C DD/MAS NMR spectrum was acquired under the following conditions. For each spectrum peak after Fourier transformation, waveform separation analysis was performed by the optimization calculation of a peak shape created by a Lorentz waveform, a Gauss waveform, or a mixture of both. In the optimization calculation, an optimum value was calculated by a nonlinear least-squares method with a center position, a height, and a half-width-NMR as variable parameters. 13-15 ppm peak was picked to calculate half-width-NMR.
Instrument: JNM-ECZ500R (JEOL RESONANCE Inc.)
Measurement method: DD/MAS
Measurement nuclear frequency: 124.50 MHz (¹³C nuclei)
Sample tube: Zirconia 3.2 mm cp
Sample spinning frequency: 10 kHz
Spectrum width: 62.5 kHz
Pulse width: 2.76 psec (90° pulse)
Pulse repetition time: 10 sec
Measurement points: 2048
Measurement Temperature: 31° C.

### Embodiments

Embodiment 1. A method of producing a copolymer, the method comprising
polymerizing monomers including 1,3-diene structure and having 4 to 20 carbons in a solvent in a presence of an anionic polymerization initiator to produce a copolymer,
wherein a temperature change during the polymerizing is less than 15° C.
   Embodiment 2. A method of producing a copolymer, the method comprising
polymerizing monomers including 1,3-diene structure and having 4 to 20 carbons in a solvent in a presence of an anionic polymerization initiator, and
cooling a temperature during the polymerizing so that a consistency of the copolymer is 6 mol % or less.
   Embodiment 3. The method according to Embodiment 2, wherein the cooling comprises maintaining a temperature change during the polymerizing to be less than 15° C.
   Embodiment 4. The method according to any one of the preceding Embodiments, wherein the temperature change during the polymerizing is less than 10° C.
   Embodiment 5. The method according to any one of the preceding Embodiments, wherein the temperature change during the polymerizing is 8° C. or less.
   Embodiment 6. The method according to any one of the preceding Embodiments, wherein a starting temperature of the polymerizing is from 10 to 90° C.
   Embodiment 7. The method according to any one of the preceding Embodiments, wherein a starting temperature of the polymerizing is from 40 to 70° C.
   Embodiment 8. The method according to any one of the preceding Embodiments, wherein the monomers include butadiene.
   Embodiment 9. The method according to any one of the preceding Embodiments, wherein the monomers include isoprene.
   Embodiment 10. The method according to any one of the preceding Embodiments, wherein the monomers include 7,11-dimethyl-3-methylene-1,6,10-dodecatriene (β-famesene).
   Embodiment 11. The method according to any one of the preceding Embodiments, wherein the only monomers polymerized in the polymerizing consist of butadiene.
   Embodiment 12. The method according to any one of Embodiments 1-10, wherein the only monomers polymerized in the polymerizing consist of isoprene.
   Embodiment 13. The method according to any one of Embodiment 1-10, wherein the only monomers polymerized in the polymerizing consist of 7,11-dimethyl-3-methylene-1,6,10-dodecatriene (β-farnesene).
   Embodiment 14. The method according to any one of the preceding Embodiments, further comprising hydrogenating the copolymer, thereby producing a α-olefin random copolymer.
   Embodiment 15. The method according to any one of the preceding Embodiments, wherein the copolymer is ethylene-1-butene copolymer.
   Embodiment 16. The method according to any one of the preceding Embodiments, wherein the copolymer has a weight average molecular weight from 10,000 to 500,000 Da.
   Embodiment 17. The method according to any one of the preceding Embodiments, wherein the copolymer has a content of vinyl bond structural units from 5 to 85 mol %.
   Embodiment 18. A method of producing a block copolymer, the method comprising polymerizing first aromatic vinyl compounds to produce polymerized aromatic vinyl compounds, and
producing the copolymer according to the method of any one of the preceding Embodiments, thereby producing the block copolymer comprising the polymerized first aromatic vinyl compounds and the copolymer, wherein the solvent contains the polymerized first aromatic vinyl compounds.
   Embodiment 19. A method of producing a tri-block copolymer, the method comprising
producing the block copolymer according to the method of Embodiment 18, and
polymerizing second aromatic vinyl compounds on the block copolymer, thereby producing the ti-block copolymer comprising the polymerized first aromatic vinyl compounds, the copolymer, and the polymerized second aromatic vinyl compounds.
   Embodiment 20. The method according to Embodiment 18 or 19, wherein the first and second aromatic vinyl compounds independently comprise a compound selected from the group consisting of styrene, α-methylstyrene, 4-methylstyrene, o-methylstyrene, m-methylstyrene, β-methylstyrene, 2,6-dimethylstyrene, 2,4-dimethylstyrene, α-methyl-o-methylstyrene, α-methyl-m-methylstyrene, α-methyl-p-methylstyrene, β-methyl-o-methylstyrene, β-methyl-m-methylstyrene, β-methyl-p-methylstyrene, 2,4,6-trimethylstyrene, α-methyl-2,6-dimethylstyrene, α-methyl-2,4-dimethylstyrene, 3-methyl-2,6-dimethylstyrene, f-methyl-2,4-dimethylstyrene, o-chlorostyrene, m-chlorostyrene, p-chlorostyrene, 2,6-dichlorostyrene, 2,4-dichlorostyrene, α-chloro-o-chlorostyrene, α-chloro-m-chlorostyrene, α-chloro-p-chlorostyrene, β-chloro-o-chlorostyrene, β-chloro-m-chlorostyrene, β-chloro-p-chlorostyrene, 2,4,6-trichlorostyrene, α-chloro-2,6-dichlorostyrene, α-chloro-2,4-dichlorostyrene, β-chloro-2,6-dichlorostyrene, β-chloro-2,4-dichlorostyrene, o-t-butylstyrene, m-t-butylstyrene, p-butylstyrene, o-methoxystyrene, m-methoxystyrene, p-methoxystyrene, o-chloromethylstyrene, m-chloromethylstyrene, p-chloromethylstyrene, o-bromomethylstyrene, m-bromomethylstyrene, p-bromomethylstyrene, silyl group-substituted styrene derivatives, indene, and vinylnaphthalene.
   Embodiment 21. The method according to any one of Embodiments 18-20, wherein each of the first and second aromatic vinyl compounds comprise styrene.
   Embodiment 22. The method according to Embodiments 18-21, wherein the tri-block copolymer has a content of vinyl bond structural units from 5 to 85 mol %.
   Embodiment 23. The method according to any one of Embodiments 19-22, wherein the tri-block copolymer has a styrene content from 5 wt % to 70 wt %.
   Embodiment 24. The method according to any one of Embodiments 19-23, wherein the tri-block copolymer has a glass transition temperature (Tg) from −60° C. to 25° C. as measured with DSC at 10° C./min.
   Embodiment 25. The method according to any one of Embodiments 19-24, wherein the tri-block copolymer has MFR at 230° C. and 2.16 kg of 250 g/10 min or less measured according to ISO1133.
   Embodiment 26. The method according to any one of Embodiments 18-25, wherein the first and second aromatic vinyl compounds are polymerized by ionic polymerization.
   Embodiment 27. The method according to any one of the preceding Embodiments, wherein the anionic polymerization initiator comprises at least one initiator selected from the group consisting of alkali metals; alkaline earth metals; lanthanoid rare earth metals; and compounds containing earth metals and lanthanoid rare earth metals.
   Embodiment 28. The method according to Embodiment 27, wherein the anionic polymerization initiator comprises at least one initiator selected from the group consisting of alkali metals, compounds containing alkali metals, and organic alkali metal compounds.
   Embodiment 29. The method according to Embodiment 27, wherein the anionic polymerization initiator comprises at least one alkali metal selected from the group consisting of lithium, sodium and potassium.
   Embodiment 30. The method according to Embodiment 27, wherein the anionic polymerization initiator comprises at least one alkaline earth metal selected from the group consisting of beryllium, magnesium, calcium, strontium and barium.
   Embodiment 31. The method according to Embodiment 27, wherein the anionic polymerization initiator comprises at least one lanthanoid rare earth metal selected from the group consisting of lanthanum and neodymium.
   Embodiment 32. The method according to Embodiment 27, wherein the anionic polymerization initiator comprises at least one organic alkali metal compound selected from the group consisting of methyl lithium, ethyl lithium, n-butyl lithium, sec-butyl lithium, t-butyl lithium, hexyl lithium, phenyl lithium, stilbene lithium, dilithiomethane, dilithionaphthalene, and 1,4-dilithiobutane.
   Embodiment 33. The method according to Embodiment 27, wherein the anionic polymerization initiator comprises an organic lithium compound.
   Embodiment 34. The method according to Embodiment 27, wherein the anionic polymerization initiator comprises at least one organic lithium compound selected from the group consisting of dilithiobutane, 1,4-dilithio-2-ethylcyclohexane, 1,3,5-trilithiobenzene, sodium naphthalene, and potassium naphthalene.
   Embodiment 35. The method according to any one of the preceding Embodiments, wherein the solvent comprises at least one selected from the group consisting of saturated aliphatic hydrocarbons, cyclopentane, cyclohexane, methylcyclohexane, saturated alicyclic hydrocarbons, and aromatic hydrocarbons.
   Embodiment 36. The method according to any one of the preceding Embodiments, wherein the solvent comprises at least one saturated aliphatic hydrocarbon selected from the group consisting of n-pentane, isopentane, n-hexane, n-heptane, and isooctane.
   Embodiment 37. The method according to any one of the preceding Embodiments, wherein the solvent comprises at least one selected from the group consisting of pentane, benzene, toluene, and xylene.
   Embodiment 38. The method according to any one of the preceding Embodiments, wherein the solvent further comprises a Lewis base.
   Embodiment 39. The method according to any one of the preceding Embodiments, wherein the solvent further comprises at least one Lewis base selected from the group consisting of dibutyl ether, diethyl ether, tetrahydrofuran, dioxane, tetramethylethylenediamine, hexamethyltriethylenetetramine, 1,2-diethoxypropane, ditetrahydrofurylpropane, and ethylene glycol diethyl ether; pyridine; tertiary amines; alkali metal alkoxides; and phosphine compounds.
   Embodiment 40. The method according to Embodiment 38 or 39, wherein an amount of the Lewis base is in the range of 0.01-1000 molar equivalent with respect to 1 mol of the anionic polymerization initiator.
   Embodiment 41. The method according to any one of the preceding Embodiments, the method further comprising adding a polymerization terminator to the solvent.
   Embodiment 42. The method according to Embodiment 41, wherein the polymerization terminator comprises an alcohol.
   Embodiment 43. The method according to any one of the preceding Embodiments, the method further comprising precipitating the tri-block copolymer in another solvent.
   Embodiment 44. The method according to any one of the preceding Embodiments, the method further comprising washing the polymerization reaction liquid with water, separating, and drying.
   Embodiment 45. A tri-block copolymer produced by the method of any one of Embodiments 19-44.

1. A method of producing a copolymer, the method comprising
polymerizing monomers including 1,3-diene structure and having 4 to 20 carbons in a solvent in a presence of an anionic polymerization initiator to produce a copolymer,
wherein a temperature change during the polymerizing is less than 15° C., or
the method further comprises cooling a temperature during the polymerizing so that a consistency of the copolymer is 6 mol % or less.

2. The method according to claim 1, wherein the temperature change during the polymerizing is less than 15° C.

3. The method according to claim 1, wherein the method further comprises the cooling.

4. The method according to claim 1, wherein the method further comprises the cooling, and the cooling comprises maintaining a temperature change during the polymerizing to be less than 15° C.

5. The method according to claim 1, wherein the temperature change during the polymerizing is less than 10° C.

6. The method according to claim 1, wherein the temperature change during the polymerizing is 8° C. or less.

7. The method according to claim 1, wherein a starting temperature of the polymerizing is from 10 to 90° C.

8. The method according to claim 1, wherein a starting temperature of the polymerizing is from 40 to 70° C.

9. The method according to claim 1, wherein the monomers include butadiene.

10. The method according to claim 1, wherein the monomers include isoprene.

11. The method according to claim 1, wherein the monomers include 7,11-dimethyl-3-methylene-1,6,10-dodecatriene (β-farnesene).

12. The method according to claim 1, wherein the only monomers polymerized in the polymerizing consist of butadiene.

13. The method according to claim 1, wherein the only monomers polymerized in the polymerizing consist of isoprene.

14. The method according to claim 1, wherein the only monomers polymerized in the polymerizing consist of 7,11-dimethyl-3-methylene-1,6,10-dodecatriene (β-farnesene).

15. The method according to claim 1, further comprising hydrogenating the copolymer, thereby producing a α-olefin random copolymer.

16. The method according to claim 1, wherein the copolymer is ethylene-1-butene copolymer.

17. The method according to claim 1, wherein the copolymer has a weight average molecular weight from 10,000 to 500,000 Da.

18. The method according to claim 1, wherein the copolymer has a content of vinyl bond structural units from 5 to 85 mol %.

19. A method of producing a block copolymer, the method comprising
polymerizing first aromatic vinyl compounds to produce polymerized aromatic vinyl compounds, and
producing the copolymer according to the method of claim 1, thereby producing the block copolymer comprising the polymerized first aromatic vinyl compounds and the copolymer, wherein the solvent contains the polymerized first aromatic vinyl compounds.

20. A method of producing a ti-block copolymer, the method comprising
producing the block copolymer according to the method of claim 19, and
polymerizing second aromatic vinyl compounds on the block copolymer, thereby producing the ti-block copolymer comprising the polymerized first aromatic vinyl compounds, the copolymer, and the polymerized second aromatic vinyl compounds.
